(19) United States
(12) Patent Application Publication
(10) Pub. No.: US 2008/0040491 A1
(43) Pub. Date: Feb. 14, 2008

(54) Method and System of Accreditation for a Client Enabling Access to a Virtual Network for Access to Services

(75) Inventors: David Minodier, Lannion (FR); Gilles Ivanoff, Trebeurden (FR)

Correspondence Address: LOWE HAUPTMAN HAM & BERNER, LLP, 1700 DIAGONAL ROAD, SUITE 300, ALEXANDRIA, VA, 22314, US

(73) Assignee: FRANCE TELECOM SA, Paris (FR)

(21) Appl. No.: 10/598,595

(22) PCT Filed: Mar. 2, 2005
(86) PCT No.: PCT/EP05/02156

§ 371 Date: Aug. 17, 2007

(30) Foreign Application Priority Data
Mar. 3, 2004 (EP) 04290584.4

(51) Int. Cl. G06F 15/16

(52) U.S. Cl. 709/229

(57) ABSTRACT

A client is authenticated for access to a virtual network so the client can access services provided by service providers. The compatibility of the client with a predetermined access control protocol for access to the virtual network is determined. If the client is not compatible with the predetermined access control protocol, data transfer is authorised between the client and at least one subscription system for subscribing the client to at least one service provider. If the client subscribes to at least one service provider, there is a transfer to the client of (1) an authentication for accessing the services of the service provider to which the client is subscribed and (2) information which makes it possible to make the client compatible with the predetermined access control protocol.

The present invention relates to a method and a system for authenticating a client for access to a telecommunication network which allows the client to access services provided by service providers.

The invention concerns the field of authenticating clients that wish to subscribe to services provided by service providers in a telecommunication network, such as the Internet for example, and to do so via point-to-point connections with a Digital Subscriber Line Access Multiplexor. These connections are for example connections of the DSL type. DSL is the acronym for “Digital Subscriber Line”. These connections may also be wireless connections or fibre optic connections between each client and the Digital Subscriber Line Access Multiplexor to which the clients are connected.

In conventional Internet access systems which use connections for example of the DSL type, each client is connected to a Digital Subscriber Line Access Multiplexor which is itself connected to a PPP session concentrator. PPP is the acronym for “Point-to-Point Protocol”. A PPP session is a session which is established according to a point-to-point protocol. A PPP session concentrator is conventionally referred to as a BAS, the acronym for Broadband Access Server. A PPP session concentrator leads the sessions established by the various clients of the network to the point of presence of the service provider to which they are subscribed.

When a new client wishes to subscribe to services offered by a DSL type service provider, an ATM virtual channel VC is created by an operator between the DSL modem of the new client and the server BAS. The virtual channels of the clients subscribed to the same service provider are grouped into virtual paths or VPs between the different Digital Subscriber Line Access Multiplexors and the PPP session concentrator.

When the client wishes to create, modify or cancel its subscription, it is often necessary to modify the virtual path that has been or will be used by the virtual channel of the client. To do this, human interventions are necessary in order to redimension the virtual path between the Digital Subscriber Line Access Multiplexor to which the client is connected and the PPP session concentrator. For example, it is often necessary to remove the virtual path which exists between the Digital Subscriber Line Access Multiplexor to which the client is connected and the PPP session concentrator in order to create a new virtual path. For all the clients connected to the PPP session concentrator, this gives rise to a break in supply of the services offered by the service provider. Such a break thus penalizes all the clients connected to the PPP session concentrator.

Networks of the GigaEthernet type are known, which offer a very high bandwidth for information transmission. A network of the GigaEthernet type is a high-speed telecommunication network based on Ethernet technology. A network of the GigaEthernet type allows data transfer at speeds of more than one Gigabit per second. These systems use access control protocols for access to a network, such as, for example, the protocol as defined in the IEEE 802.1x standard. The access control protocol as defined in the IEEE 802.1x standard is also referred to as an authentication protocol. This protocol requires that the client which wishes to connect to the network has software that is compatible with the protocol used. This type of access control protocol is designed for office local networks or for predefined groups of clients, but was not envisaged in telecommunication networks which allow a multitude of clients with varied equipment and software to access the Internet via a DSL-type connection.

The object of the invention is to overcome the disadvantages of the prior art by proposing a method and a system for authenticating a client for access to a virtual network which allows the client to access services provided by service providers, in which human intervention on the telecommunication network is not necessary. Moreover, the invention aims to guarantee to the clients that the services provided by the service providers to which they are subscribed will not be interrupted when a new client subscribes or modifies its subscription to the same service provider to which they are subscribed. Furthermore, the invention aims to make it possible for clients with varied equipment and software to subscribe to a service provider automatically, even if said clients do not have software that is compatible with the access control software used in the telecommunication network.

To this end, according to a first aspect, the invention proposes a method for authenticating a client for access to at least one virtual network which allows the client to access the services of at least one service provider, the or each virtual network being set up on a telecommunication network, characterised in that it comprises the steps of determining the compatibility of the client with a predetermined access control protocol for access to the virtual network, and, if the client is not compatible with the predetermined access control protocol, authorizing data transfer between the non-compatible client and at least one subscription system for subscribing the client to at least one service provider via an authentication network which is different from the or each virtual network which allows a client to access the services of the or each service provider, and, if the non-compatible client subscribes to at least one service provider via an authentication network, transferring to the non-compatible client an authentication for accessing the virtual network which allows access to the services of the service provider to which the non-compatible client is subscribed and information which makes it possible to make the client compatible with the predetermined access control protocol.

At the same time, the invention relates to a system for authenticating a client for access to at least one virtual network which allows the client to access the services of at least one service provider, the or each virtual network being set up on a telecommunication network, characterised in that it comprises means for determining the compatibility of the client with a predetermined access control protocol for access to the telecommunication network, authorization means for authorizing, if the client is not compatible with the predetermined access control protocol, data transfer between the non-compatible client and at least one subscription system for subscribing the client to at least one service provider via a network which is different from the virtual networks which allow a client to access the services of a service provider, and means for transferring to the non-compatible client, if the non-compatible client subscribes to at least one service provider, an authentication for accessing the virtual network which allows access to the services of the service provider to which the non-compatible client is subscribed and information which makes it possible to make the client compatible with the predetermined access control protocol.

Thus, clients with varied equipment and software can access one or more virtual networks in order to subscribe to a service provider automatically, even if said clients do not have software that is compatible with the access control mechanism used in the telecommunication network. According to another aspect of the invention, the authentication network is a virtual network or a network that is separate from the telecommunication network.

According to another aspect of the invention, the subscription system consists of at least one subscription portal, an authentication material server and, when the client subscribes to a service, the subscription portal transfers to an authentication server data associated with the authentication transferred to the client.

According to another aspect of the invention, the client is connected to the network via a Digital Subscriber Line Access Multiplexor and, if the client is compatible with the predetermined access control protocol, the Digital Subscriber Line Access Multiplexor obtains an identifier and a client authentication material as well as a client authentication confirmation from the authentication server.

Thus, it is possible to verify whether a client is or is not authorised to access a service provider and thus to prevent the client from accessing unauthorized services.

According to another aspect of the invention, if the authentication server does not confirm the authentication of the client, data transfer is authorised between the client and at least one subscription system for subscribing the client to at least one service provider via an authentication network which is different from the virtual networks which allow a client to access the services of at least one service provider.

Thus, a client which does not have a valid authentication material is nevertheless able to access a subscription system with a view to obtaining a valid authentication material.

According to another aspect of the invention, information associated with the service provider to which the client is subscribed and/or information characterizing the service to which the client is subscribed is also transferred to the authentication server.

Thus, all the information necessary for determining the services which the client can access as well as the speed or speeds selected by the client at the time of its subscription are stored in a single server. It is then possible to categorise the offers made by the service providers and to guarantee that these offers are respected. Moreover, when authorization confirmations are sent to the authentication server, the latter can at the same time provide other information necessary for defining the client's rights.

According to another aspect of the invention, the Digital Subscriber Line Access Multiplexor authorizes data transfer between the virtual network which allows the client to access the services of the service provider to which the client is subscribed according to the communication speed or speeds to which the client is subscribed.

Thus, any modification in the communication speeds allocated to the client is carried out automatically.

According to another aspect of the invention, an address server is also associated with the virtual authentication network, and the address server allocates an address to the client for data transfer on the virtual authentication network.

Thus, the client can obtain an address in the telecommunication network which then allows it to subscribe to the services provided by a service provider. According to another aspect of the invention, the telecommunication network is a network of the GigaEtherriet type, and the predetermined access control protocol is a protocol of the IEEE 802.1x type, and the clients are connected to the Digital Subscriber Line Access Multiplexor via connections of the DSL type.

The invention also relates to computer programs stored on an information support, said programs comprising instructions which make it possible to carry out the authentication method described above when it is loaded and run by a computer system.

The features of the invention that have been mentioned above, along with others, will become more clearly apparent on reading the following description of an example of embodiment, said description being given with reference to the appended drawings, in which:

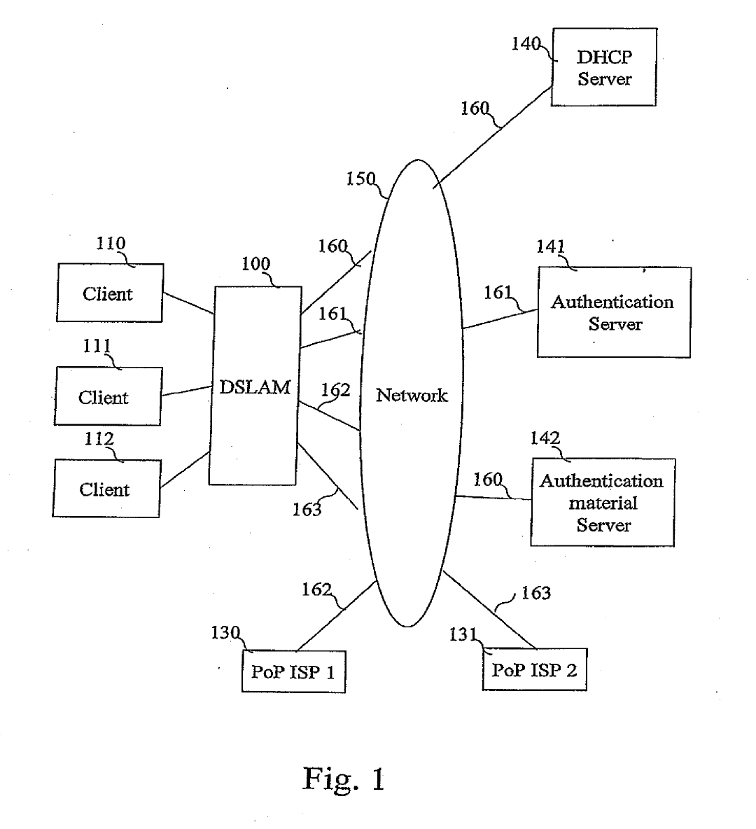

FIG. 1 shows the architecture of the system for authenticating a client for access to a telecommunication network which allows the client to access services provided by service providers;

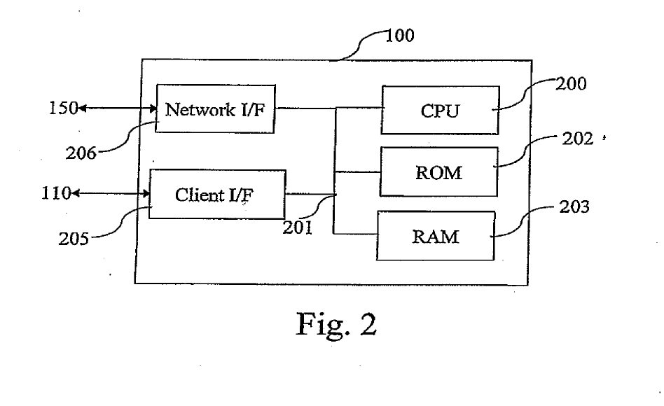

FIG. 2 shows a block diagram of the Digital Subscriber Line Access Multiplexor of the present invention;

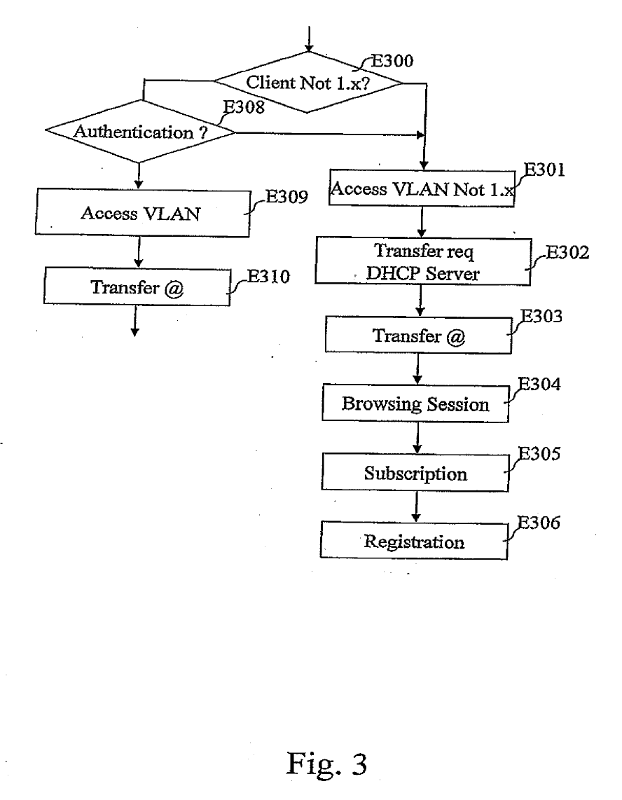

FIG. 3 shows the algorithm for authenticating a client for access to a telecommunication network which allows the client to access services provided by service providers.

FIG. 1 shows the architecture of the system for authenticating a client for access to a telecommunication network which allows the client to access services provided by service providers.

The system for authenticating a client on a telecommunication network comprises a Digital Subscriber Line Access Multiplexor 100. In one preferred embodiment, the Digital Subscriber Line Access Multiplexor 100 is a Digital Subscriber Line Access Multiplexor suitable for point-to-point connections with clients 110, 111 and 112. If the connections are of the DSL type, the Digital Subscriber Line Access Multiplexor 100 is known by the term DSLAM. DSLAM is the acronym for “Digital Subscriber Line Access Multiplexer”.

The Digital Subscriber Line Access Multiplexor 100 has the function of grouping together several client lines 110, 111 and 112 on a physical support which transports the data exchanged between the clients 110, 111 and 112 and service providers 130 and 131. A client is for example a telecommunication device such as a computer comprising a communication card suitable for the connection that exists with the Digital Subscriber Line Access Multiplexor 100 or a computer which is connected to an external communication device suitable for the connection that exists with the Digital Subscriber Line Access Multiplexor 100.

More specifically, the clients 110, 111 and 112 are telecommunication terminals and are connected to the Digital Subscriber Line Access Multiplexor 100 via the telephone network and use DSL-type modulation techniques. Of course, other types of point-to-point connection may be used. For example, and without any limitation, these connections may also be wireless connections or fibre optic connections. The Digital Subscriber Line Access Multiplexor 100 authorizes access to the services offered by the service providers 130 and 131 for example to the clients 111 and 112 if said clients are compatible with an access control protocol such as, for example, the IEEE 802.1x protocol, and if said clients are registered in a database associated with their service provider 130 or 131 and it authentication of said clients has been validated by an authentication server 141 associated with their service provider 130 or 131. For this, the Digital Subscriber Line Access Multiplexor 100 comprises a client software module which transmits authentication requests to a server 141 when a client 110, 111 or 112 wishes to access the services offered by a service provider connected to the network 150. The client software module is preferably a RADIUS client software module, that is to say one which conforms to the RADIUS protocol, and the server 141 is preferably an authentication server of the RADIUS type which also conforms to the RADIUS protocol. RADIUS is the acronym for “Remote Authentication Dial In User Service”. It should be noted here that other types of authentication protocol may be used in the present invention. These protocols are for example, and without any limitation, of the “Diameter” or “TACACS”® type, the latter being an acronym for “Terminal Access Controller Access Control System”, or an authentication protocol which uses an authentication server.

The Digital Subscriber Line Access Multiplexor 100 authorizes a client, such as the client 110, access to a subscription system 142 for subscribing to a service provider 130 or 131 when the client 110 does not have software that is compatible with the access control protocol, such as the IEEE 802.1x protocol for example. The subscription system 142, via the Digital Subscriber Line Access Multiplexor 100, transfers to a client that is not compatible with the access control protocol the data that allow said client to become compatible with the access control protocol when registration of the client has been validated by the authentication server 141 associated with a service provider 130 or 131.

In the IEEE 802.1x protocol, three elements make up the access control architecture. The “supplicant” is the element which attempts to access the network by requesting access thereto. The ‘authenticator’ is the element which relays the information associated with authentication of the “supplicant” to the “authentication server”. The authentication server is the element which validates access of the “supplicant” to the network. The information is exchanged between the “authenticator” and the “authentication server” in accordance with the protocol EAP, the acronym for “Extensible Authentication Protocol”, which is itself encapsulated in the Radius protocol. The information exchanged between the “supplicant” and the “authenticator” conforms to the protocol EAPOL, the acronym for “EAP Over Lan”. The “supplicant” is for example the client 111, the “authenticator” is the Digital Subscriber Line Access Multiplexor 100 and the “authentication server” is the RADIUS authentication server 141 of FIG. 1.

The Digital Subscriber Line Access Multiplexor 100 is connected to the service providers 130 and 131 via points of presence PoP which are not shown in FIG. 1. The service providers 130 and 131 offer different services to their respective subscribers. These services are for example, and without any limitation, Internet access services, video-on-demand services, e-mail services, telephone-over-Internet services, videoconference-over-Internet services, etc. The Digital Subscriber Line Access Multiplexor 100 is also connected to a DHCP server 140, to a RADIUS authentication server 141 and to an authentication material server 142 via a telecommunication network 150. The telecommunication network 150 is for example a network of the GigaEthernet type. Virtual networks are set up on the telecommunication network 150 between the Digital Subscriber Line Access Multiplexor 100 and each service provider 130 and 131. A network, which is separate from the virtual networks mentioned above, is also set up for access to the subscription system for subscription to a service provider by a client that is not compatible with the IEEE 802.1x protocol. The network set up in the telecommunication network 150 for access to the subscription system for subscription to a service provider by a client that is not compatible with the IEEE 802.1x protocol is a physical network that is separate from the telecommunication network 150 or a virtual network that is set up on the telecommunication network 150. Virtual networks or VLANs, an acronym for “Virtual Local Area Networks”, make it possible to categorise the clients and thus to the limit the resources to which they have access. For example, if the client 111 is a client of the service provider 130, the exchanges between the client 111 and the service provider 130 are carried out via the VLAN symbolized by the connections bearing the reference 162 in FIG. 1. The client 111 on the other hand cannot access the services offered by the service provider 131, since the latter is associated with another VLAN which bears the reference 163 and is different from the VLAN 162.

The DHCP server 140 distributes IPv4 addresses to the clients, for example to the client 110 when said client wishes to subscribe to the services offered by one of the service providers 130 or 131. DHCP is the acronym for “Dynamic Host Configuration Protocol”. It should be noted here that the DHCP server may, as a variant, distribute addresses of the IPv6 type when this protocol is used.

The authentication server 141 is the authentication server according to the IEEE 802.1x protocol and in one preferred embodiment conforms to the RADIUS protocol. The RADIUS authentication server 141 authenticates a client, for example the client 111, to the Digital Subscriber Line Access Multiplexor 100 when the client 111 wishes to access the service provider 130. Here, authentication of a client refers both to the authentication of the client device 110 or of the user of the client device. This authentication is carried out on the basis of the client's identifier, such as its username, and the provision by the client of a password or of an authentication material that has been validated by the authentication server 141. Upon receipt of this confirmation, the Digital Subscriber Line Access Multiplexor 100 authorizes data transfer between the client 111 and the service provider 130 via the virtual network 162 if the client 111 has previously subscribed to the services offered by the service provider 130. In the same way, the RADIUS authentication server 141 authenticates the client 112 to the Digital Subscriber Line Access Multiplexor 100 when the client 112 wishes to access the services offered by the service provider 131. Upon receipt of this confirmation, the Digital Subscriber Line Access Multiplexor 100 authorizes data transfer between the client 112 and the service provider 131 via the virtual network 163 if the client 112 has previously subscribed to the services offered by the service provider 131.

A virtual network bearing reference 161 is also dedicated to transporting authentication data between the Digital Subscriber Line Access Multiplexor 100 and the RADIUS authentication server 141.

The RADIUS authentication server 141 also comprises the attributes associated with the clients connected to the Digital Subscriber Line Access Multiplexor 100. These attributes are, for example, the virtual network or networks which the client 110, 111 or 112 has a right to access, as well as other information such as, for example, the data transfer speed to which the client subscribes or the service provider or providers to which the client is subscribed, the type of applications hosted by the client, etc. Associated with the RADIUS authentication server 141 is a client database which stores all the clients which are able to access the services offered by the various service providers 130 and 131 connected to the network 150, the attributes which make up the profile of a client 111 or 112, as well as an identifier for each client 111 or 112. This identifier is associated with a password or an authentication material which is issued by an authentication material server 142.

In one particular embodiment, the authentication material server 142 also performs the function of a subscription portal and, when a client accesses this portal, the client 110 can subscribe to a service offered by one of the service providers 130 or 131 associated with the network.

If a client, for example the client 110, does not have software that is compatible with the access control protocol, such as the IEEE 802.1x protocol for example, said client is authorised to access the authentication network 160. The authentication network 160 is for example a virtual network 160. A DHCP server 140 and an authentication material server 142 are connected to the virtual network 160. Via the DHCP server 140, the client 110 which does not have software that is compatible with the IEEE 802.x protocol obtains an address and can thus establish communication with the authentication material server 142 and subscribe to the services offered by one or more service providers 130 and/or 131.

It should be noted here that the RADIUS authentication server 141, which can be accessed via the virtual network 161, can also as a variant be a RADIUS authentication proxy server which redirects the transferred information to RADIUS authentication servers (not shown in FIG. 1) which are associated with each service provider 130 and 131. According to this variant, each Radius authentication service associated with each service provider 130 and 131 stores all the clients which are able to access the services offered by the service provider with which it is associated, as well as the attributes which make up the profile of a client, the identifier for each client and the password or authentication material issued by the authentication material server 142.

It should also be noted that the DHCP server 140 which can be accessed via the virtual network 160 may also as a variant be a DHCP relay or “proxy” server which redirects the transferred information to DHCP servers (not shown in FIG. 1) which are associated with each service provider 130 and 131.

A proxy is an item of equipment which receives information from a first telecommunication device and transfers it to a second telecommunication device, and, reciprocally, which receives information from the second telecommunication device and transfers it to the first telecommunication device.

FIG. 2 shows a block diagram of the Digital Subscriber Line Access Multiplexor of the present invention.

The Digital Subscriber Line Access Multiplexor 100 comprises a communication bus 201 to which a central processing unit 200, a non-volatile memory 202, a random-access memory 203, a client interface 205 and a network interface 206 are connected.

The non-volatile memory 202 stores the programs which implement the invention, such as the client RADIUS software module and at least part of the algorithm which will be described below with reference to FIG. 3. The non-volatile memory 202 is for example a hard disk. More generally, the programs according to the present invention are stored in a storage means. This storage means can be read by a computer or a microprocessor 200. This storage means may or may not be integrated in the Digital Subscriber Line Access Multiplexor 100, and may be removable. When the Digital Subscriber Line Access Multiplexor 100 is powered up, the programs are transferred to the random-access memory 203 which then contains the executable code of the invention and also the data necessary for implementing the invention.

The Digital Subscriber Line Access Multiplexor 100 also comprises a telecommunication network interface 206. This interface allows data transfers between the service providers 130 and 131 and/or the DHCP server 140 and/or the RADIUS authentication server 141 and/or the authentication material server 142.

The Digital Subscriber Line Access Multiplexor 100 also comprises a client interface 205. In one preferred embodiment, this interface is an interface of the DSL type. The client interface 205 comprises, for each client 110, 111 and 112, a dedicated port for point-to-point communications between the Digital Subscriber Line Access Multiplexor 100 and the client connected to this port.

The processor 200 is able to authorize or not authorize data transfer between the telecommunication network interface 206 and each port of the client interface 205 connected to a client, as a function of the authentication of the client.

According to the preferred embodiment, the connection between the Digital Subscriber Line Access Multiplexor 100 and each client 110, 111 and 112 is a wired connection using the respective telephone line of the clients 110, 111, 112. Of course, it is also possible for other connections, such as connections of the coaxial, radio or fibre optic type, to be used as a variant.

FIG. 3 shows the algorithm for authenticating a client for access to a telecommunication network which allows the client to access services provided by service providers.

In step E300, the processor 200 of the Digital Subscriber Line Access Multiplexor 100 detects a connection request for connecting a client to the telecommunication network which allows the client to access services provided by service providers. In this step, the processor 200 verifies whether the client is compatible with the access control protocol, such as the IEEE 802.1x protocol for example. This is determined for example by verifying whether the information transmitted by the client 110 conforms to the EAPOL protocol. More specifically, the processor 200 verifies whether the client is compatible with the IEEE 802.1x protocol by verifying whether said client transmits or is able to respond to a frame of the EAPoL-Start type of the IEEE 802.1x protocol. In the affirmative, the processor 200 moves to step E308. In the negative, the processor 200 moves to step E301.

In step E301, having determined that the client is not compatible with the IEEE 802.1x protocol, the processor 200 treats said client as a new client and authorizes the new client, for example the client 110, to access a predetermined virtual network A subscription system is connected to this virtual network or VLAN which bears the reference 160 in FIG. 1. This subscription system comprises a DHCP server 140 and also an authentication material server 142. The client 110 can then establish communications with the DHCP server 140 and also the authentication material server 142. This virtual network 160 is dedicated to clients which do not have the 802.1x functionality or to clients which do not have a valid authentication material.

Once this operation has been carried out, in step E302 the client 110 requests an address, such as an IP address for example, from the DHCP server 140 via the Digital Subscriber Line Access Multiplexor 100 and the virtual network 160.

This IP address is transferred to the client 110 in step E303.

Following receipt of this IP address, in step E304 the client 110 launches a browsing session with the aid of a browser of the telecommunication terminal and a connection is set up to a subscription portal. The subscription portal is preferably integrated in the authentication material server 142. Of course, the subscription portal can be separate from the authentication material server 142 but in this case must be connected to the virtual network 160. In the case where the subscription portal is separate from the authentication material server 142, the authentication material server 142 is not necessarily connected to the virtual network 160. In this case, the subscription portal communicates directly or indirectly with the authentication material server 142. It should be noted that, with this architecture, if each service provider 130 or 131 has a subscription portal, each subscription portal then has to be connected to the virtual network 160. As a variant, all of the authentication material servers of each of the service providers can be accessed from a single subscription portal which is managed by one of the service providers.

In step E305, the client 110 subscribes to a service offered by one of the service providers 130 or 131. The client 110 selects the service provider and also the speed that said client wishes to have. In general, the client 110 selects the service or services that it wishes to have from a set of services offered by the selected service provider. Subscription of a client to a service offered by one of the service providers 130 or 131 in this case means the subscription of the user of the client device 100 to a service offered by one of the service providers 130 or 131.

In the next step E306, registration of the client 110 takes place. This registration consists in updating of the client database associated with the RADIUS authentication server 141 by the authentication material server 142 comprising the subscription portal. An identifier for the client 110 is then stored in association with a password or an authentication material, such as a certificate, and the data associated with the service or services to which the client has subscribed. If, for example, the client 110 has subscribed to the service provider 130, said client will then be authorised to access the virtual network 162 like all the clients of the service provider 130. In this step, an identifier and a password or an authentication material are also transferred to the client 110, along with the information which make it possible to make the client 110 compatible with the 802.1x protocol. This information comprises for example a command for activation of the “supplicant” 802.1x software if said software is already present in the communication device of the client 110 or a visual and/or acoustic message inviting the client 110 to activate the 802.1x software, or for loading the “supplicant” 802.1x software and also installing and activating it in the communication device of the client 110.

Once this operation has been carried out, the processor 200 returns to step E300. The processor 200 detects a new connection request for connecting the client 110 to the telecommunication network which allows the client to access services provided by service providers.

In this step, the processor 200 verifies whether the client is compatible with the access control protocol, such as the IEEE 802.1x protocol for example. Since the client 110 has become compatible in the previous step E306, the processor 200 moves to step E308.

In this step, verification of the authentication of the client is carried out. For this, the Digital Subscriber Line Access Multiplexor 100 receives from the communication device of the client 110 an identifier and a password or an authentication material.

The processor 200 of the Digital Subscriber Line Access Multiplexer 100 commands the transfer of a registration confirmation request to the authentication server, for example the RADIUS server 141, via the virtual network 161. The RADIUS authentication server 141 searches in the client database to determine whether the client 110 is contained in the client database, verifies the validity of the password or of the authentication material and, in the affirmative, transfers a confirmation of registration of the client 110 to the Digital Subscriber Line Access Multiplexor 100 along with the profile associated with the client 110 which comprises information such as the virtual network which the client 110 is authorised to access, the speed to be allocated to the client 110 etc. If registration of the client 110 is confirmed, the processor 200 moves to step E309.

If registration of the client 110 is not confirmed, the processor 200 of the Digital Subscriber Line Access Multiplexor 100 authorizes data transfer between the client 110 and at least one subscription system for subscribing the client to at least one service provider via the virtual network 160 dedicated to clients which do not have the 802.1x functionality or which do not have a valid authentication material. To do this, the processor 200 moves to step E301 described above.

In the next step E309, the processor 200 of the Digital Subscriber Line Access Multiplexor 100 authorizes access to the virtual network which the client 110 is authorised to access after applying all of the parameters characterizing the service to which the client has subscribed, such as for example the speed to be allocated to this service, the priority of the service and/or the quality associated with the service.

In the next step E310, if the client 110 does not have an IP address allocated beforehand by the service provider to which said client is subscribed, an IP address which allows the client 110 to access the subscribed service is allocated by a DHCP server associated with the service provider to which the client 110 has subscribed.

The client 110 can thus access services provided by the service provider 130 or 131 to which said client is subscribed.

Of course, the present invention is in no way limited to the embodiments described here but rather, on the contrary, encompasses any variant within the capabilities of the person skilled in the art.

1. Method of authenticating a client for access to at least one virtual network which allows the client to access the services of at least one service provider, the or each virtual network being set up on a telecommunication network, the method comprising:
determining the compatibility of the client with a predetermined access control protocol for access to the virtual network,
if the client is not compatible with the predetermined access control protocol, authorizing data transfer between the client and at least one subscription system for subscribing the client to at least one service provider via an authentication network which is different from the or each virtual network which allows a client to access the services of the or each service provider,
if the non-compatible client subscribes to at least one service provider via the authentication network, transferring to the non-compatible client an authentication for accessing the virtual network which allows access to the services of the service provider to which the non-compatible client is subscribed and information which makes it possible to make the client compatible with the predetermined access control protocol.

2. Method according to claim 1, wherein the authentication network is a virtual network or a network that is separate from the telecommunication network.

3. Method according to claim 1, wherein the subscription system includes at least one subscription portal, an authentication material server and, in response to the client subscribing to a service, the subscription portal transfers to an authentication server data associated with the authentication transferred to the client.

4. Method according to claim 3, wherein the client is connected to the network via a Digital Subscriber Line Access Multiplexer and, if the client is compatible with the predetermined access control protocol, the Digital Subscriber Line Access Multiplexor performs the steps of obtaining an identifier and a client authentication material and of obtaining a client authentication confirmation from the authentication server.

5. Method according to claim 4, wherein if the authentication server does not confirm the authentication of the client, the method comprises a step of authorizing data transfer between the client and at least one subscription system for subscribing the client to at least one service provider via an authentication network which is different from the virtual networks which allow a client to access the services of at least one service provider.

6. Method according to claim 3, wherein there is a transfer to the authentication service of information associated with the service provider to which the client is subscribed and/or information characterizing the service to which the client is subscribed.

7. Method according to claim 6, wherein the authentication server additionally transfers to the Digital Subscriber Line Access Multiplexor the information associated with the service provider to which the client is a client and/or the information relating to the service or services to which the client is subscribed.

8. Method according to claim 7, wherein the Digital Subscriber Line Access Multiplexor authorizes data transfer between the virtual network which allows the client to access the services of the service provider to which the client is subscribed according to the communication speeds to which the client is subscribed.

9. Method according to claim 1, wherein an address server is also associated with the virtual authentication network, and the address server allocates an address to the client for data transfer on the virtual authentication network

10. Method according to claim 1, wherein the telecommunication network is a high-speed network based on Ethernet technology, and the predetermined access control protocol is a protocol of the IEEE 802.1x type, and the clients are connected to the Digital Subscriber Line Access Multiplexor via connections of the DSL type.

11. System for authenticating a client for access to at least one virtual network for allowing the client to access the services of at least one service provider, the or each virtual network being set up on a telecommunication network, the system comprising;
means for determining the compatibility of the client with a predetermined access control protocol for access to the telecommunication network,
authorization means for authorizing, if the client is not compatible with the predetermined access control protocol, data transfer between the non-compatible client and at least one subscription system
for subscribing the client to at least one service provider via a network which is different from the virtual networks which allow a client to access the services of a service provider,
means for transferring to the non-compatible client, if the non-compatible client subscribes to at least one service provider via the authentication network, an authentication for accessing the virtual network which allows access to the services of the service provider to which the non-compatible client is subscribed and information which makes it possible to make the client compatible with the predetermined access control protocol.

12. A computer readable medium or storage device carrying a computer program including instructions for enabling a computer to carry out the authentication method of claim 1.

13. Digital Subscriber Line Access Multiplexor which allows at least one client to access the services of at least one service provider, the client line multiplexer being arranged for relaying the information transmitted by the client and associated with authentication of the client to an authentication server.

14. Multiplexer according to claim 13, wherein the client line multiplexer includes a software module according to the IEEE 802.1x standard for relaying the information associated with authentication.
